(19) United States
(12) Patent Application Publication
(10) Pub. No.: US 2014/0082894 A1
(43) Pub. Date: Mar. 27, 2014

(54) SEATBELT BUCKLE RETAINING DEVICE

(71) Applicant: BLUESCAPE INVESTMENTS PTY LTD, Chatswood, New South Wales (AU)

(72) Inventors: Kelly Walker, Randwick New South Wales (AU); Grant Alan Walker, Randwick New South Wales (AU)

(73) Assignee: BLUESCAPE INVESTMENTS PTY LTD, Chatswood, New South Wales (AU)

(21) Appl. No.: 14/009,246

(22) PCT Filed: Mar. 22, 2012
(86) PCT No.: PCT/AU2012/000300

§ 371 Date: Dec. 11, 2013

(30) Foreign Application Priority Data
Apr. 6, 2011 (AU) 2011201548

(51) Int. Cl. B60N 2/28

(52) U.S. Cl. CPC B60N 2/2803
USPC 24/303

(57) ABSTRACT

A seatbelt buckle retaining device comprising a clamp device for attachment to a magnetic device arranged to retain a seatbelt buckle when in use, wherein the clamp device is arranged to: i) capture the magnetic device when in use and only release the magnetic device upon activation of a clasp device, and ii) locate under a car seat cover, or be permanently affixed within a car seat or car seat cover.

### FIELD OF THE INVENTION

The present invention relates to a seatbelt retaining device. In particular, the present invention relates to a seatbelt retaining device for attachment to car seats or car seat covers, as well as car seat or car seat covers including a seat belt retaining device or magnetic device.

### BACKGROUND

Infant car seats are used in vehicles to ensure the infant is securely restrained in a suitable device when travelling in the vehicle.

However, at times, it can be inconvenient when trying to seat the child in the seat while at the same time locating and inserting the seat belt buckle into the appropriate catch.

This problem is mainly due to the seatbelt buckles becoming inaccessible due to them being located on the car seat when the child is being placed in the seat, resulting in the child being placed on the seat with the seat belt buckles underneath them. Alternatively, the seatbelt buckles may have moved or fallen behind or underneath the seat itself, causing the adult problems in trying to retrieve the buckles in order to secure the child in the seat. This problem can of course be exacerbated if the child is particularly young and is attempting to get out of the seat while being placed in it, or if the adult only has one arm free while trying to secure the seatbelt.

One prior known system described in Japanese Patent Publication 2001-158263 utilises a magnetic device which is attached to a car seat by way of adhesive tape. However, this device has particular safety issues associated with it. For example, the device described provides a magnetic attraction between the metal buckle of the seat belt and the metal surface of the magnetic device. This attraction between two metal surfaces may cause injury to a small child if their skin is caught between the two surfaces. As a further example, the device described may be pulled off the chair by the child due to it only being attached by adhesive tape. The device may then be thrown by the child inside the vehicle, which could potentially result in a very dangerous situation.

Further, the device described in 2001-158263 could only be attached to one position on the car seat before the adhesive tape becomes less adhesive, thus resulting in the device easily being detached from the seat. Also, the use of the adhesive tape means that there is limited opportunity for repositioning the device to adjust its effectiveness.

An object of the present invention is to provide a more convenient system for assisting with the process of securing a child in a car seat.

A further object of the present invention is to provide a more secure attachment mechanism for retaining a seat belt buckle.

Each object is to be read disjunctively with the object of at least providing the public with a useful choice.

The present invention aims to overcome, or at least alleviate, some or all of the afore-mentioned problems.

The background discussion (including any potential prior art) is not to be taken as an admission of the common general knowledge.

### SUMMARY OF THE INVENTION

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components that the use directly references, but optionally also the inclusion of other non-specified components or elements.

According to one aspect, the present invention provides a seatbelt buckle retaining device including a clamp device for attachment to a magnetic device arranged to retain a seatbelt buckle when in use, wherein the clamp device is arranged to: i) capture the magnetic device when in use and only release the magnetic device upon activation of a clasp device, and ii) locate under a car seat cover, or be permanently affixed within a car seat or car seat cover.

According to a further aspect, the present invention provides a seatbelt buckle retaining device including a clamp device and a magnetic device, wherein the clamp device is arranged to physically clamp the magnetic device when in use and only release the magnetic device upon activation of a clasp device, and the magnetic device is arranged to magnetically retain a seatbelt buckle when in use, wherein the clamp device is further arranged to locate under a car seat cover, or be permanently affixed within a car seat or car seat cover.

According to yet a further aspect, the present invention provides a car seat including a seatbelt buckle retaining device, wherein the seatbelt buckle retaining device includes a clamp device for attachment to a magnetic device arranged to retain a seatbelt buckle when in use, wherein the clamp device is permanently affixed within the car seat and is arranged to capture the magnetic device when in use and only release the magnetic device upon activation of a clasp device.

According to yet a further aspect, the present invention provides a car seat cover including a seatbelt buckle retaining device, wherein the seatbelt buckle retaining device includes a clamp device for attachment to a magnetic device arranged to retain a seatbelt buckle when in use, wherein the clamp device is permanently affixed within the car seat cover and is arranged to capture the magnetic device when in use and only release the magnetic device upon activation of a clasp device.

According to yet a further aspect, the present invention provides a car seat including a seatbelt buckle retaining device, wherein the seatbelt buckle retaining device includes a metal plate for attachment, when in use, to a seatbelt buckle which includes a magnetic device wherein the metal plate is permanently affixed within the car seat.

According to yet a further aspect, the present invention provides a car seat cover including a seatbelt buckle retaining device, wherein the seatbelt buckle retaining device includes a metal plate for attachment, when in use, to a seatbelt buckle which includes a magnetic device wherein the metal plate is permanently affixed within the car seat cover.

According to yet a further aspect, the present invention provides a car seat having at least one magnetic device permanently fixed therein, wherein the magnetic device is arranged and located to retain a seatbelt buckle used to secure a person in the car seat.

According to yet a further aspect, the present invention provides a car seat cover having at least one magnetic device permanently attached thereto, wherein the magnetic device is arranged and located to retain a seatbelt buckle used to secure a person in a car seat covered by the car seat cover.

### BRIEF DESCRIPTION OF THE DRAWINGS

Embodiments of the present invention will now be described, by way of example only, with reference to the accompanying drawings, in which:

FIG. 1 shows a top perspective view of a seat belt buckle retaining device according to an embodiment of the present invention;

FIG. 2 shows a bottom perspective view of a seat belt buckle retaining device according to an embodiment of the present invention;

FIG. 3 shows a partially exploded view of a seat belt buckle retaining device according to an embodiment of the present invention;

FIG. 4 shows an exploded view of a seat belt buckle retaining device according to an embodiment of the present invention;

FIG. 5 shows a side view of a seat belt buckle retaining device according to an embodiment of the present invention;

FIG. 6 shows a cross sectional view of a seat belt buckle retaining device according to an embodiment of the present invention;

FIG. 7 shows the seat belt buckle retaining devices in use on a car seat according to an embodiment of the present invention;

### DETAILED DESCRIPTION OF THE INVENTION

### First Embodiment

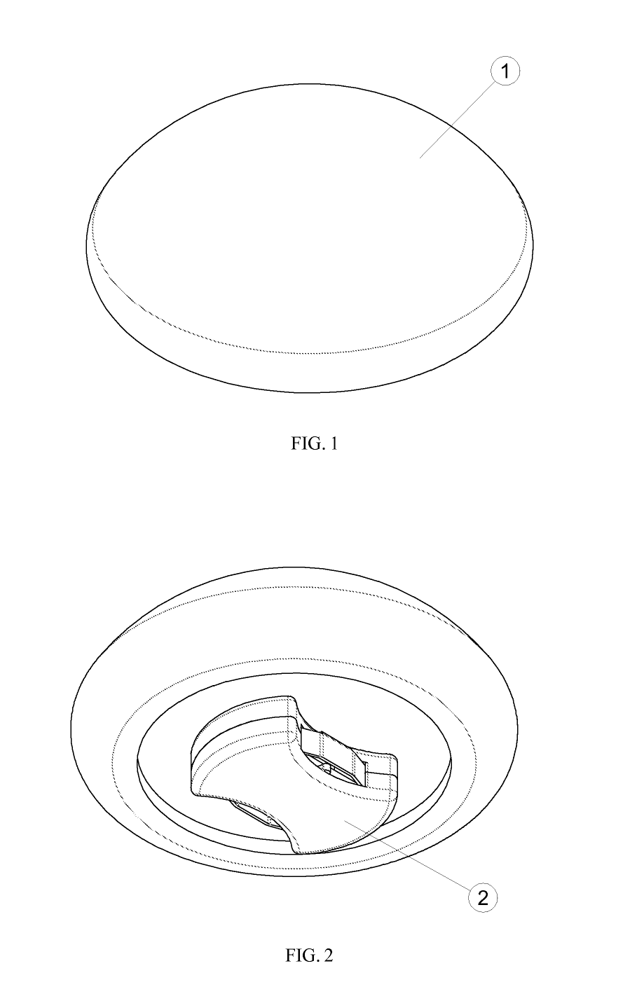

FIG. 1 shows a top perspective view of a seat belt buckle retaining device according to this embodiment.

A dome shaped magnetic device 1 is shown. The magnetic device in this view includes a silicon cover placed over a magnet in order to avoid scratching the seatbelt buckles or the magnet. As an alternative, the cover may be made from PVC, polyurethane or a fabric material.

The cover restricts magnetic attraction of metal to metal surfaces and so provides increased safety by avoiding any injury to a child who may get their skin caught between the two surfaces.

Further, the silicon cover may include a surface design of a picture, image or the like in order to distract and entertain the child whilst being securely strapped in the car seat.

The cover also provides an advantage in that it covers the metal of the magnet and so stops the magnet heating up when placed in the sun. This prevents the child, or indeed the parent, from being burnt by the hot magnet. Also, the cover may be easily removed and cleaned by the parent of the child.

It will be understood that the silicon cover is not so thick that the magnetic field of the magnet underneath it does not extend past the cover. For example, the silicon cover has a thickness between 2 and 3 mm. However, it will be understood that the thickness of the cover may be more or less than this depending on the magnetic attraction between the magnet and the seatbelt buckle. For example, the silicon cover may be 4 mm or more thick for slightly stronger magnets, or less than 2 mm for weaker magnets.

FIG. 2 shows a bottom perspective view of the seat belt buckle retaining device. As can be seen in FIG. 2, a clamp device 2 is arranged to attach to the underside of the magnetic device, as will be explained in more detail below.

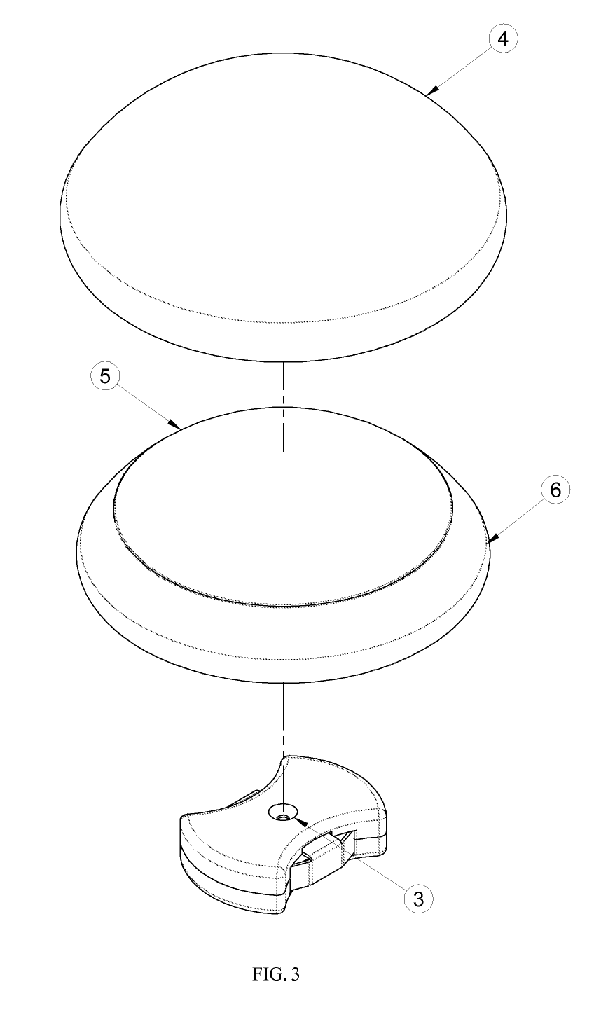

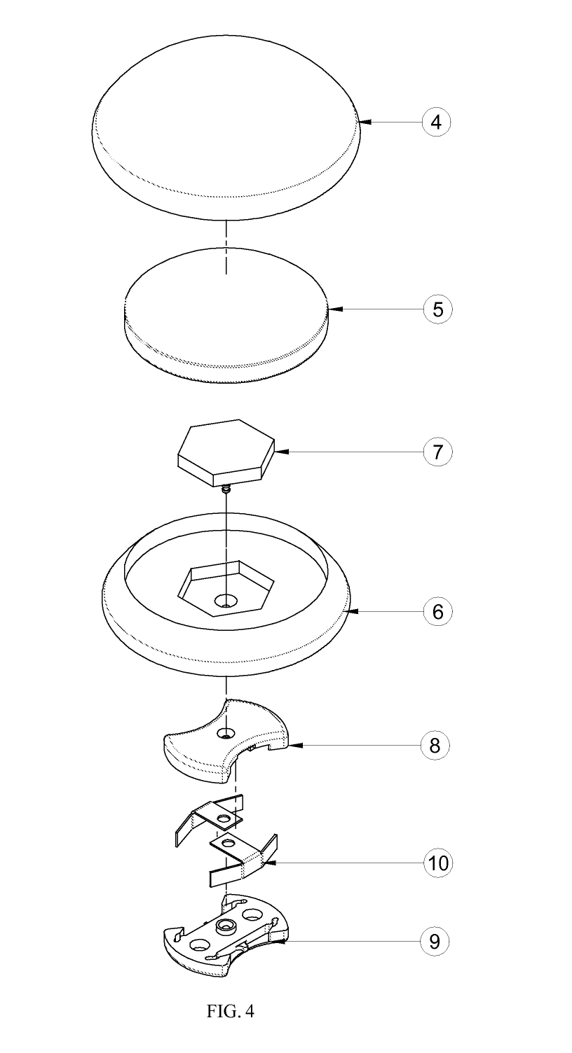

FIG. 3 shows a partially exploded view of the seat belt buckle retaining device. In this view, the silicon cover 4 is shown separated from the magnet 5. The magnet is housed within a main body housing 6. The housing 6 is formed or moulded from a plastic material to receive the magnet 5.

The clamp device 3 includes an aperture 301 for receiving a pin component as explained in more detail below. Activation members 10 within the clamp device enable the clamp device to clamp onto the pin component. The activation members 10 may be depressed and released by a user in order to open up and close the recess 301 respectively.

FIG. 4 shows an exploded view of the seat belt buckle retaining device.

As can be seen in FIG. 4, the silicon cover 4 is placed over the magnet 5 and housing 6. Located within the housing 6 is the pin component 7. The pin component is formed from steel and includes a hexagonal shaped top surface 701 that locates within a corresponding hexagonal recess 601 within the housing 6. Extending perpendicularly from the centre of the hexagonal shaped top surface 701 of the pin component 7 is an extrusion 703 in the form of a pin.

It will be understood that the pin component may be formed from any other suitable material, such as a different metal, or a hard durable plastic. It will also be understood that the top surface of the pin component may take other forms other than a hexagonal shape.

The pin 703 of the pin component 7 passes through an aperture 603 that passes through a lower surface of the housing 6 in the centre of the hexagonal recess 603. Therefore, when the pin component 7 is located in the recess 601, it is not able to rotate.

The clamp device 3 includes an upper casing 8 and a lower casing 9, which clip together by applying force to press the two casings together. That is, in this embodiment the upper and lower casings are attached by way of a press fit mechanism. It will be understood that, as an alternative, the upper and lower casings may be plastic welded or glued together. The upper casing 8 includes the aperture 301 for receiving the pin 703 of the pin component 7.

Located within the clamp device casing (8, 9) are the activation members 10 in the form of two spring components. Each spring component locates within a recess 901 within the lower casing, as well as in a corresponding opposing recess (not shown) in the upper casing.

Each spring component is formed from a T-shaped stainless steel component. As an alternative, the spring component may be made from a strong flexible plastic material. The T-shaped component includes three portions along the top of the “T” shape; a central portion, a left portion and a right portion. The left and right portions are bent away from the central portion at an angle of approximately 5°. It will be understood that the bend angle may be varied above or below 5°, but that the bending of the left and right portions enables each spring component to locate within the recess 901 while also enabling the spring component to be flexed by the user when in use.

The “T” shaped component also includes an upright portion which is bent over at an angle of approximately 90° away from the central portion so that it lies in the same plane as the upper and lower surfaces of the casing when the spring component is located in the recesses 901.

The left and right portions form wings that locate within the recesses 901 of the upper and lower casing, while the central portion is movably located within the recesses 901 so that applying pressure to the central portion causes the upright portion to move towards the centre of the casing.

As the two spring components 10 are positioned in the recesses 901 so that they oppose each other, the upright portions of the spring components overlap. Within the upright portion of each spring component 10 is located an aperture 1001. When assembled, as the spring components are moved by a user pressing the central portions towards each other, the apertures gradually start to overlap until they fully overlap providing a full circular recess. As the springs are released, the apertures in each spring component move away from each other so that they only partially overlap. This provides a catch mechanism for the pin of the pin component.

The pin of the pin component can therefore be pressed through the aperture 301 within the upper casing 8 and through the apertures 1001 of the spring components 10 by the user without the user having to move or activate the activation members 10. This is because the profile of the pin enables the pin to pass through the partial opening of the overlapped apertures 1001 of the spring components 10 and slide through the apertures until the pin reaches a locked position, as explained below.

To release the pin from the spring components the user presses the central portions of the spring components together to open up the overlapping apertures 1001 in the spring component and enable the pin to be released from the clamp device.

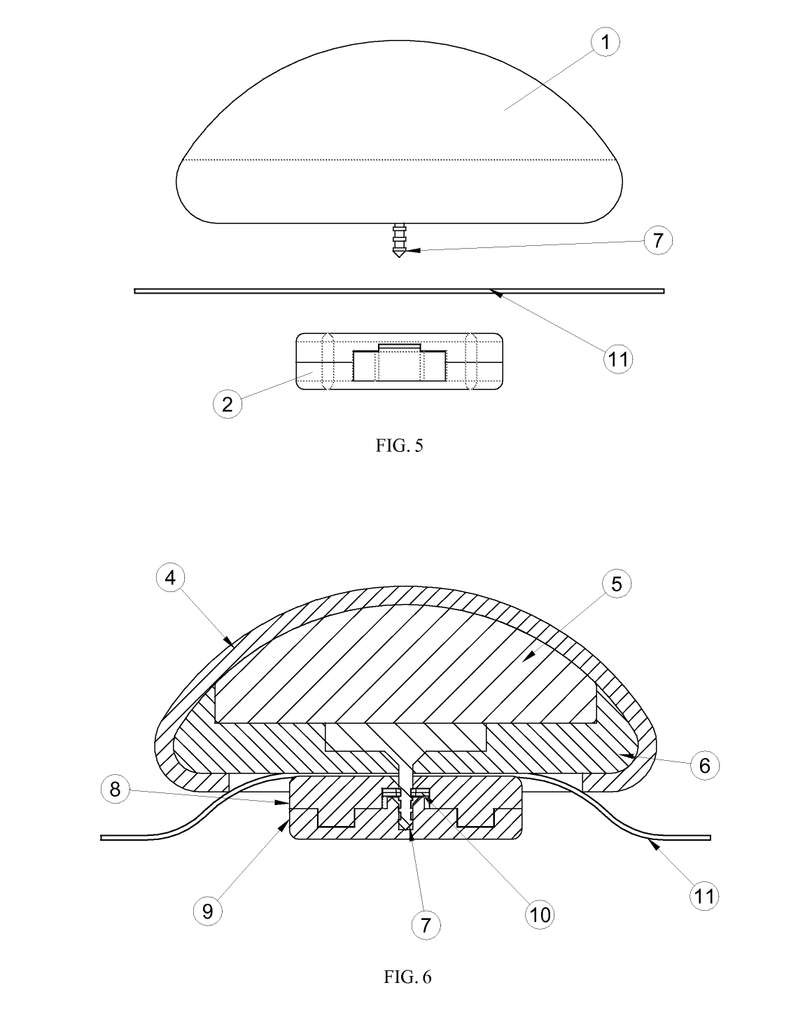

FIG. 5 shows a side view of the seat belt buckle retaining device. The surface of the pin on the pin component is more clearly shown. The pin surface according to this embodiment has a stepped profile, i.e. circumferential circular recesses located around the pin's surface. According to this embodiment, the pin includes three recesses to enable it to be positioned at one of three levels against the car seat cover. Alternatively, it will be understood that there may be one, two or more than three seating positions for the pin by varying the profile and number of recesses. Also, it will be understood that be other profiles of the pin surface may be envisaged. For example, a screw thread may be provided on the pin to enable the spring components to catch hold and retain the pin.

Therefore, with no force applied by a user to the central portion of the spring component, the pin is captured as the pin's stepped surface passes through the overlapping spring component apertures 1001. That is, the surface edges around the apertures in the spring components rest against the stepped profile of the pin surface so the pin is not able to be retracted. However, when a force is applied to the central portion by the user, the spring component apertures align and provide enough space to free the pin's stepped profile and allow the pin to pass through the spring component apertures and out of the clamp device 2.

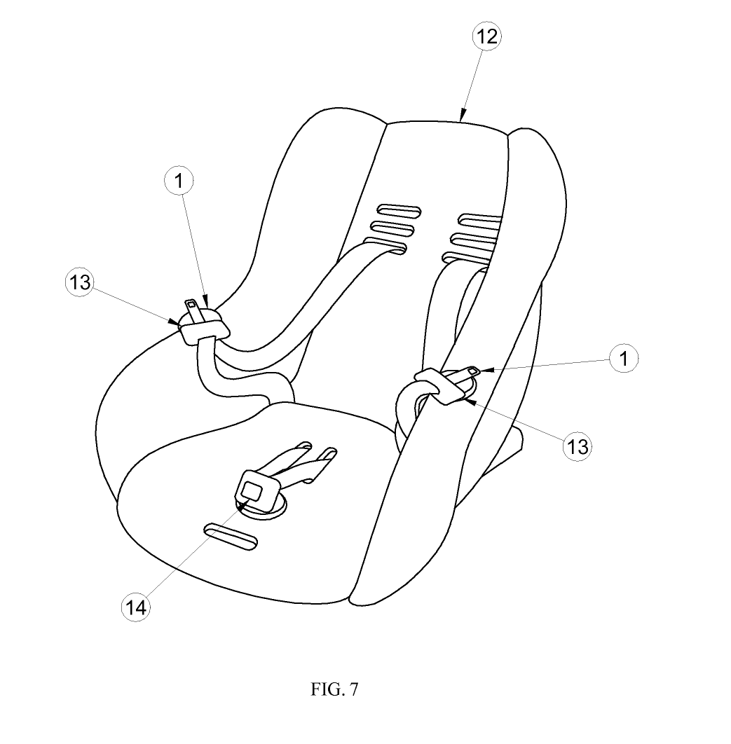

FIG. 6 shows a cross sectional view of the seat belt buckle retaining device.

This cross sectional view shows a car seat cover 11, which may form part of the child car seat. As can be seen in this figure, the magnet 5, housing 6, silicon cover 4 and top surface 701 of the pin component 7, all forming part of the magnetic device 1, are located on the outside or on top of the car seat cover 11. The pin portion of the pin component 7 passes through the car seat cover 11 and passes through the aperture of the upper casing 8 of the clamp device 3, where the pin is held in position by the spring components 10.

This provides an improved mechanism for securing the magnetic device 1 to the car seat cover 11. The magnetic device cannot easily be removed without the user finding and activating the activation members 10.

FIG. 7 shows the seat belt buckle retaining device described above in use on a car seat 12. In this figure the metal seat belt buckles (13, 14) are placed on top of the magnetic devices 1 that are securely attached to the seat 12. In this example, a first magnetic device is attached to the left arm of the seat, a second magnetic device is attached to the right arm of the seat and a third magnetic device is attached to the front portion of the seated area of the seat. Each magnetic device includes a separate clamp device located under the seat cover. It will be understood that the clamp device may be permanently or semi-permanently attached to the car seat cover. Alternatively, the clamp device may be sewn into the car seat cover.

In this way, the three components of the seat belt system can be placed or positioned in a more convenient place to enable a user to place their child within the seat without the need to struggle with moving the buckles at the same time. Further, as the child grows and the seat belt is adjusted to accommodate the larger child, the magnets are easily moved or repositioned to improve effectiveness of the device.

As the clamp device is located underneath the car seat cover it is not visible to the child within the car seat and so it is extremely unlikely that they would release the clamp device from the magnetic device. Further, a reasonable level of physical co-ordination, dexterity and strength is required to release the clamp device from the magnetic device making it hard for young children to manipulate and release the magnetic device from the clamp.

It will be understood that the clamp device may be arranged to be permanently or semi-permanently affixed to a seat or seat cover when in use. Further, it will be understood that the clamp device may be either a non-magnetic or magnetic material.

### Second Embodiment

According to this second embodiment, a car seat or car seat cover may be formed having a magnet permanently attached to it in any number of strategic positions to enable a user to place the car seat belt buckles in these positions.

Alternatively, a clamp device, such as that described above, may be permanently affixed within a car seat or car seat cover by moulding, sewing, gluing or any other suitable attachment method. A magnetic device may then be attached to the clamp device to perform the function as described above. The activation members of the clamp device may be modified to make them accessible to enable a user to release the magnetic device attached to the clamp device.

According to this second embodiment, a magnet may be moulded into a car seat on the arms of the car seat and/or on the seated portion of the car seat in order to capture the car seat belt buckles in a similar manner to that shown in FIG. 7. For example, the car seat may be a plastic or foam car seat specifically designed for use with children. By moulding the magnet into the car seat, the magnet becomes permanently affixed within the car seat. This ensures the magnet cannot be removed and cause a potential hazard. The magnet may be fitted into the car seat so that at least a portion of the magnet is visible when viewing the car seat. For example, a top portion of the magnet may be visible initially but is then covered by a car seat cover. The seat belt buckle would then be attracted to and attached to the magnet via the car seat cover.

Alternatively, the magnet may be fully embedded within the car seat. It will be understood that the depth of the magnet must not exceed a depth whereby the magnetic field does not penetrate the surface of the car seat enough to keep the car seatbelt buckle in place.

As a further example, a magnet may be permanently affixed to a car seat cover by any suitable means such as moulding, sewing or gluing (or indeed attaching using any other suitable attachment mechanism) the magnet into a desired position on the cover. For example, the magnet may be attached to the cover so that it is positioned on the underside of the car seat cover, i.e. the side of the cover that is in contact with the car seat, and out of view of the user. However, it will be understood that, as an alternative, the magnet may be attached to or positioned upon the upper surface of the car seat cover. The location of the magnet on the cover may relate to the seat portion or arm of the car seat after the cover has been fitted to the seat.

### Further Embodiments

It will be understood that the embodiments of the present invention described herein are by way of example only, and that various changes and modifications may be made without departing from the scope of invention.

It will be understood that the configuration of the magnetic device components, including the magnet, housing, pin component and silicon cover may vary considerably. For example, the shape of the various components and how they fit together may be modified to suit the requirements of the user.

Further, it will be understood that the magnetic device described above may be formed from a single component. That is, the magnet may be formed having a pin protruding from its lower surface, where the pin may then be located and locked within the clamp device. Alternatively, the magnet and pin component formed as a single component may be located within a housing. The silicon cover is optional.

Further, it will be understood that other clamp devices and clamping methods may be used to securely hold onto the magnet or magnetic device. For example a pressing force may be applied to the outer surface of the pin of the pin mechanism from each side to hold the pin in place. Alternatively a movable clip may be pushed and locked into place to secure the pin in the desired position.

Further, it will be understood that the magnetic component of the device may be permanently or semi-permanently affixed to the seatbelt buckle. Alternatively, at least a portion or part of the seatbelt near the buckle or the seatbelt buckle itself may be formed from a magnetic material, or have attached thereto a magnetic component.

Attachment points may be permanently or semi-permanently affixed to a car seat or car seat cover at various strategic points to retain the seatbelt or buckle through magnetic attraction.

For example, the attachment points may be one or more metal plates that are permanently or semi-permanently attached to the car seat. The metal plates may be moulded into the car seat.

As a further example, the attachment points may be one or more metal plates that are permanently or semi-permanently attached to a car seat cover. The metal plates may be sewn into the car seat cover.

1. A seatbelt buckle retaining device comprising a clamp device for attachment to a magnetic device arranged to retain a seatbelt buckle when in use, wherein the clamp device is arranged to:
i) capture the magnetic device when in use and only release the magnetic device upon activation of a clasp device, and
ii) locate under a car seat cover, or be permanently affixed within a car seat or car seat cover.

2. The seatbelt buckle retaining device of claim 1 further comprising the magnetic device, wherein the magnetic device includes:
a magnet for retaining the seatbelt and
a pin component attached to the magnet,
the clamp device further arranged to retain the pin component of the magnetic device.

3. The seatbelt buckle retaining device of claim 2, wherein the pin component comprises a pin that comprises one or more recesses for locating the pin within the clamp device.

4. The seatbelt buckle retaining device of claim 2 further comprising a magnetic device housing, wherein the magnetic device housing comprises a recess for receiving the pin component.

5. The seatbelt buckle retaining device of claim 4, wherein the recess further comprises an aperture that allows a pin of the pin component to pass through for attachment to the clamp device.

6. The seatbelt buckle retaining device of claim 1 further comprising a cover arranged to fit over the magnetic device.

7. The seatbelt buckle retaining device of claim 1, wherein the clamp device further comprises a pin component in engagement with the magnetic device when in use, wherein the clamp device is arranged to retain the pin component when in use.

8. The seatbelt buckle retaining device of claim 1, wherein the clamp device further comprises a housing and a clasp device located within the housing to retain the magnetic device.

9. The seatbelt buckle retaining device of claim 8, wherein the clasp device is arranged to move within the housing to cause the magnetic device to be captured and released.

10. The seatbelt buckle retaining device of claim 8, wherein the clasp device comprises two opposing spring devices, where each spring device comprises an aperture that is movably aligned with the opposing spring device's aperture.

11. The seatbelt buckle retaining device of claim 8, wherein the clasp device comprises two opposing spring devices and the housing comprises a housing aperture, where each spring device comprises an aperture that is movably aligned with the housing aperture.

12. The seatbelt buckle retaining device of claim 11, wherein the housing aperture is arranged to receive a pin attached to the magnetic device.

13. The seatbelt buckle retaining device of claim 1 adapted for use on a car seat or car seat cover.

14. A seatbelt buckle retaining device comprising a clamp device and a magnetic device, wherein the clamp device is arranged to physically clamp the magnetic device when in use and only release the magnetic device upon activation of a clasp device, and the magnetic device is arranged to magnetically retain a seatbelt buckle when in use, wherein the clamp device is further arranged to locate under a car seat cover, or be permanently affixed within a car seat or car seat cover.

15. The seatbelt buckle retaining device of claim 14, wherein the clamp device is arranged to be placed under a seat cover to affix the magnetic device on top of the seat cover.

16. A car seat including a seatbelt buckle retaining device, wherein the seatbelt buckle retaining device comprises a clamp device for attachment to a magnetic device arranged to retain a seatbelt buckle when in use, wherein the clamp device is permanently affixed within the car seat and is arranged to capture the magnetic device when in use and only release the magnetic device upon activation of a clasp device.

17. A car seat cover including a seatbelt buckle retaining device, wherein the seatbelt buckle retaining device comprises a clamp device for attachment to a magnetic device arranged to retain a seatbelt buckle when in use, wherein the clamp device is permanently affixed within the car seat cover and is arranged to capture the magnetic device when in use and only release the magnetic device upon activation of a clasp device.

18. A car seat including a seatbelt buckle retaining device, wherein the seatbelt buckle retaining device comprises a metal plate for attachment, when in use, to a seatbelt buckle which includes a magnetic device wherein the metal plate is permanently affixed within the car seat.

19. A car seat cover including a seatbelt buckle retaining device, wherein the seatbelt buckle retaining device comprises a metal plate for attachment, when in use, to a seatbelt buckle which includes a magnetic device wherein the metal plate is permanently affixed within the car seat cover.

20. A car seat having at least one magnetic device permanently fixed therein, wherein the magnetic device is arranged and located to retain a seatbelt buckle used to secure a person in the car seat.

21. The car seat of claim 20, wherein the car seat is a child's car seat.

22. The car seat of claim 20, wherein the magnetic device is embedded within the car seat.

23. The car seat of claim 20, wherein the magnetic device is moulded into the car seat.

24. The car seat of claim 22, wherein at least a portion of the magnetic device is visible when a car seat cover is not attached to the car seat, and the car seat is suitable for attaching the car seat cover.

25. The car seat of claim 20, wherein the one or more magnetic devices are located on one or more of the arm and seat portion of the car seat.

26. A car seat cover having at least one magnetic device permanently attached thereto, wherein the magnetic device is arranged and located to retain a seatbelt buckle used to secure a person in a car seat covered by the car seat cover.

27. The car seat cover of claim 26, wherein the car seat is a child's car seat.

28. The car seat cover of claim 26, wherein the magnetic device is sewn into the car seat cover.

29. The car seat cover of claim 26, wherein the magnetic device is glued onto the car seat cover.

30. The car seat cover of claim 26, wherein the one or more magnetic devices are located on the underside or upper surface of the car seat cover.

31. The car seat of claim 20 substantially as herein described with reference to the accompanying drawings.

32. The car seat cover of claim 26 substantially as herein described with reference to the accompanying drawings.

33. A seatbelt buckle retaining device substantially as herein described with reference to the accompanying drawings.
